(19) United States
(12) Patent Application Publication
(10) Pub. No.: US 2013/0074782 A1
(43) Pub. Date: Mar. 28, 2013

(54) Combination collar and leash training aid

(71) Applicant: Megan Marran, Parkesburg, PA (US)

(72) Inventor: Megan Marran, Parkesburg, PA (US)

(73) Assignee: Megan Elizabeth Marran, Parkesburg, PA (US)

(21) Appl. No.: 13/200,588

(22) Filed: Sep. 24, 2011

Related U.S. Application Data
(60) Provisional application No. 61/403,956, filed on Sep. 24, 2010.

(51) Int. Cl. A01K 27/00

(52) U.S. Cl. CPC A01K 27/003; A01K 27/001
USPC 119/793

(57) ABSTRACT

A combination collar and leash training aid that is constructed from a continuous piece of flexible material that serves as a leash as well as one of three collars, a halter, choker, or locked flat collar. This three-in-one system eliminates the need for a large, heavy clip lead and creates a direct energy connection between the animal and handler. By eliminating the pressure the animal feels from a large, heavy clip hanging from the halter it allows for positive reinforcement to the animal as the muzzle loop exerts no pressure over the muzzle until the animal pulls. The positive reinforcement allows for a transition from the more restrictive halter position to the normal locked collar position.

### RELATED U.S. PATENT DOCUMENTS

| | | |
|---|---|---|
| David et al | #5,732,660 | Mar. 31, 1998 |
| Therrian | #12,454,754 | Nov. 25, 2010 |
| Rudolf | # 5,711,255 | Jan. 27, 1998 |
| Fields-Babineau | # 2002/0073936 | Jun. 20, 2002 |
| Bloodworth | #4,369,615 | Jan. 25, 1983 |
| Taplin | #4,584,967 | Apr. 29, 1986 |
| Wagner | # 7,281,495 | Oct. 16, 2007 |
| Borchelt et al | #5,992,353 | Nov. 30, 1997 |
| Franco | #D524997 | Jul. 11, 2006 |

### BACKGROUND OF THE INVENTION

Collars, of all types, have been used by handlers over the years to control an animal's behavior. These collars include, but are not limited to, chokers, martingales, prong or pinch collars, flat collars, and head halters. Several of these rely on pain or discomfort to control the animal and create the illusion of voluntary compliance with the handler's commands. Head halters, in particular, are used by a handler to control the forward motion, or pulling of an animal, by controlling where the head goes.

Most of the halters that are currently patented are singular entities to which a clip lead is attached with the exception of U.S. Pat. Nos. 12,454,754 and 5,732,660. The clip that is attached to the halter creates consistent pressure on the animals muzzle. This consistent pressure is often resented by the animal as there is no release of this pressure when the animal is behaving and doing what the handler wishes. As animals do not learn from pressure, but from the release of pressure, these halters are not training the animal not to pull, but simply forcing the animal to comply with what the handler desires.

Therrian, in U.S. Pat. No. 2010/0294212 A1, discloses a combination halter and animal lead made from a single piece of material, which controls the animal from behind the head instead of from the muzzle. Therrian's patent does create the ability to control an animal that pulls. However, due to the lock down mechanism behind the head, the pressure is maintained, thereby, losing its ability to train the animal not to pull. This patent stops short of providing a way of locking the choke collar so that an animal will not be injured from pressure around the throat.

David, et al, in U.S. Pat. No. 5,732,660, have a combination head halter and leash that is more complex in design. This design has a lead that can be removed from a collar that the animal wears around it's neck and the muzzle loop is formed from this lead. Once the muzzle loop is in place it functions as a halter collar, exactly as a single entity halter collar would, however, it will not give the animal any positive feedback and can only used for control and not training.

Currently, there are no head halters on the market which allow a handler to transition an animal from walking with a halter to walking with a flat collar easily. Due to the fact that the current head halters on the market are either on or not, there is no in between and no easy way to place a halter should you be in a situation that calls for it. Even in the the case of Therrian, in U.S. Pat. No. 2010/0294212 A1, though he has a choke collar available for use, it remains punitive to the animal and does not serve as a training tool, but as a restrictive device.

Currently, there is a need for a device which will more accurately communicate between the animal and the trainer. This device can function as a restrictive device when necessary, while allowing for training and positive feedback as well. This device will allow for the animal to transition from the use of the most restrictive device, a halter collar, to the choke collar, and then to a normal or flat collar for walking.

### SUMMARY OF THE INVENTION

The current invention brings into a single device an animal leash and three separate collar configurations, a halter, a choker, and a locked flat collar. This invention allows for the positive reinforcement needed for training a dog that pulls when walked, to successfully transition from using a halter, or choke collar position, to a normal lock collar position.

### BRIEF DESCRIPTION OF THE DRAWINGS

FIG. 1 is a perspective view of the present invention spread out on a surface in a flat view and in halter collar view.

FIG. 2 is a perspective view of the present invention in the leash and choker collar configuration.

FIG. 3 is a perspective view of the present invention in the halter and leash configuration.

FIG. 4 is a perspective view of the present invention in the halter and leash configuration on the head of a dog.

FIG. 5 is a perspective view of the present invention in the locked flat collar and leash configuration.

### DETAILED DESCRIPTION OF THE INVENTION

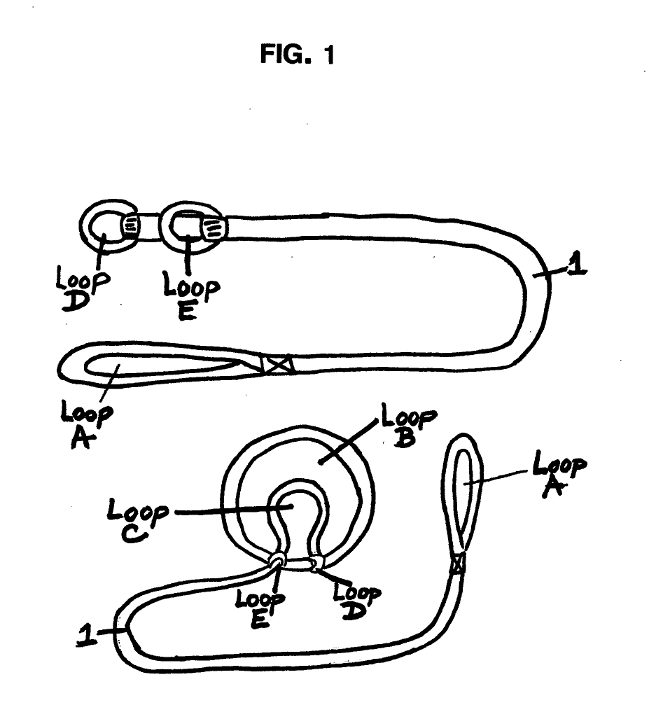

FIG. 1 Loop (A) in the two views in FIG. 1 is the handle loop. The loop shape is formed by folding back one end of the flexible material (1) upon itself and securing it. Loop (D) and loop (E) serve as both the sliding mechanisms for the device as well as the flat collar lock and are secured at the opposite end of the continuous piece of flexible material (1) from the handhold loop (A). The flexible material (1) is folded over itself and the Loops (D) and (E) are incorporated into the fold at a predetermined spacing and secured. Any number of methods may be used to secure these loops (A), (D), and (E). Some examples are knotting, sewing, gluing, stapling or weaving.

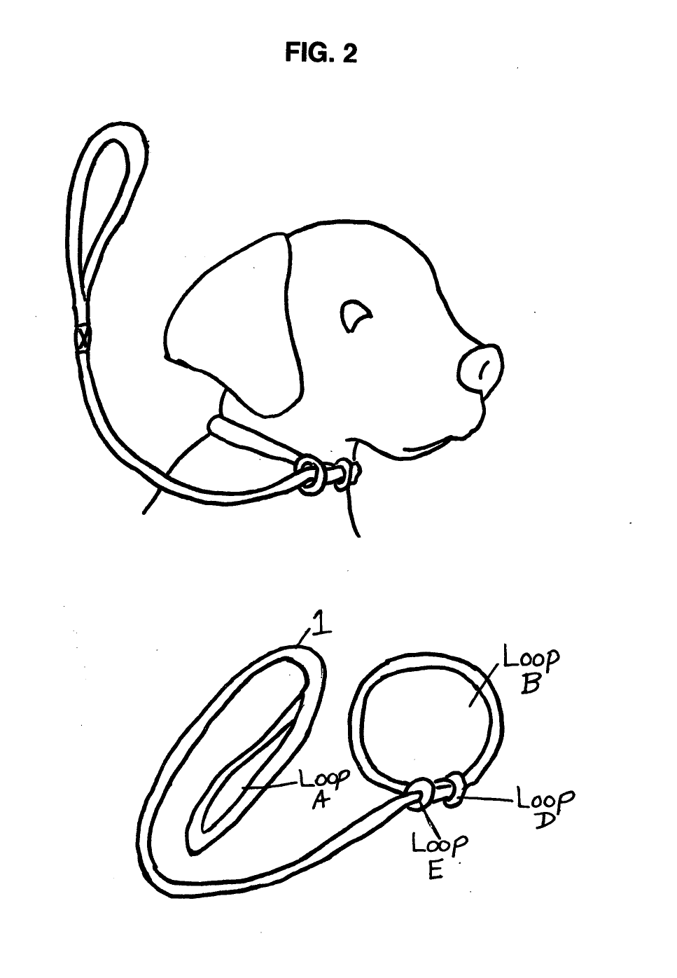

FIG. 2 depicts the choker collar and lead combination. There are two loops used in this embodiment. The loop (B) is formed by sliding loop (A) through loop (D) and loop (E). The loop (B) is then placed around the animal's neck and fit for comfort. Loop (A) is the hand hold position.

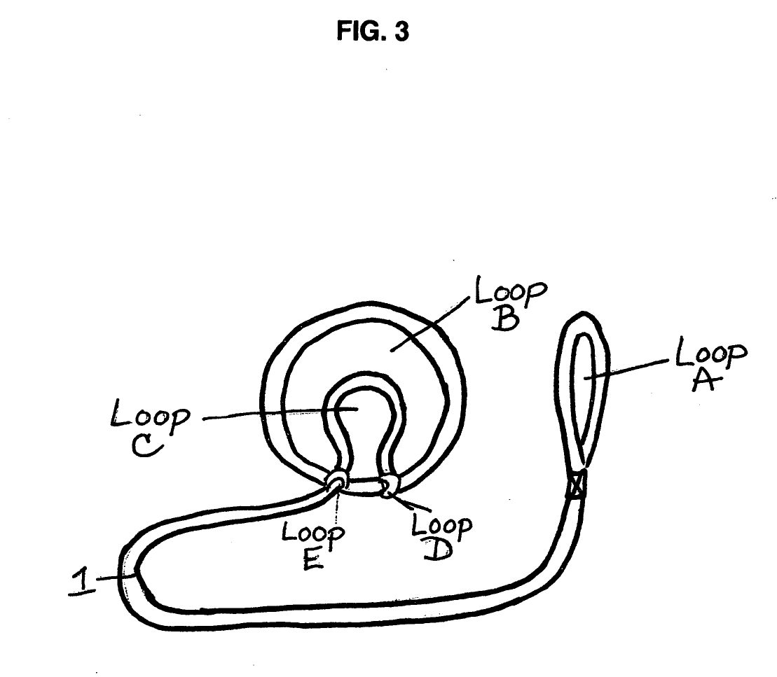

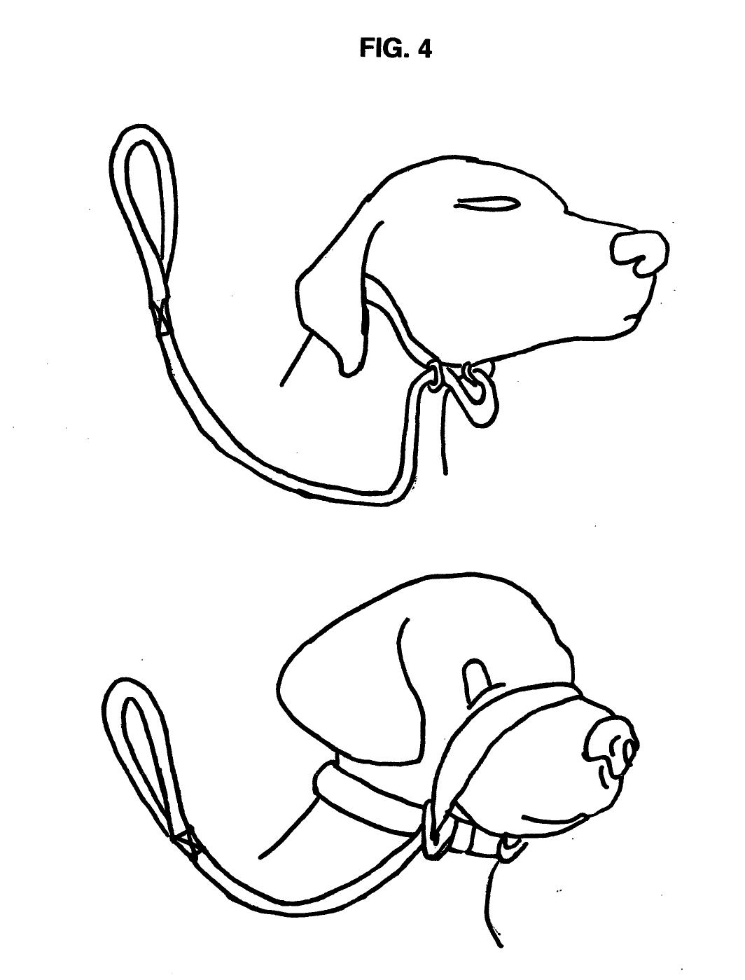

FIG. 3 depicts the halter collar and lead configuration. There are three loops used in this embodiment. Loop (B) is formed by sliding loop (A) through loop (D) and loop (E). The loop (B) is then placed around the animal's neck and fit for comfort. Loop (D) and loop (E) will be placed below the animal's jaw as in FIG. 4. Loop (B) is formed by grasping the flexible material (1) between loop (D) and loop (E) below the animal's jaw as in FIG. 4. Loop (C) is then placed lightly over the animal's muzzle as in FIG. 4. Loop (A) is the hand hold position.

FIG. 4 depicts the halter collar and lead configuration on the head of a dog. There are three loops used in this embodiment. Loop (B) is formed by sliding loop (A) through loop (D) and loop (E). The loop (B) is then placed around the animal's neck and fit for comfort. Loop (D) and loop (E) will be placed below the animal's jaw. Loop (B) is formed by grasping the flexible material (1) between loop (D) and loop (E) below the animal's jaw. Loop (C) is then placed lightly over the animal's muzzle. Loop (A) is the hand hold position.

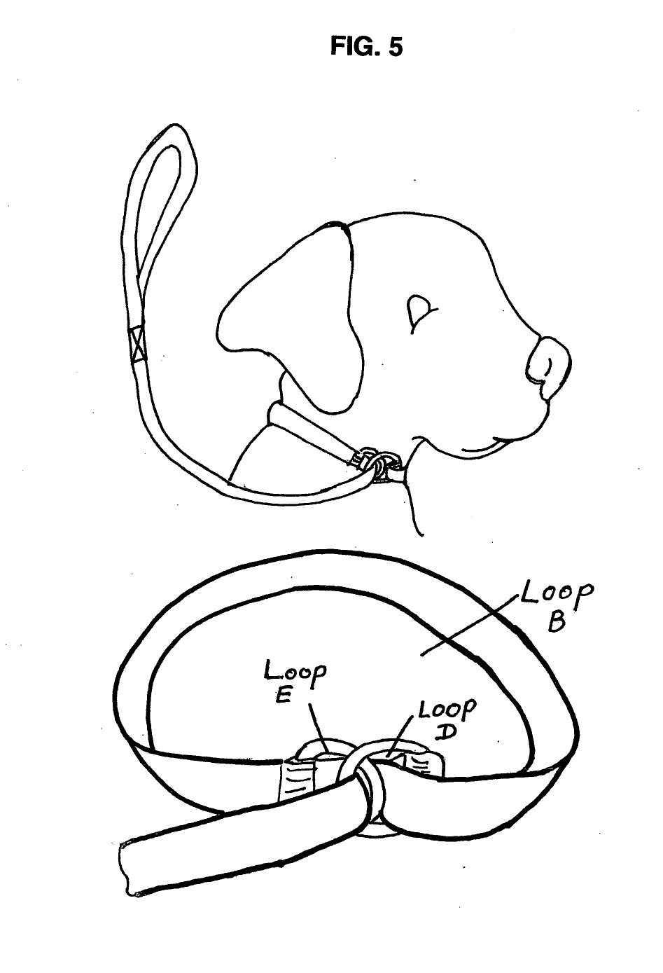

FIG. 5 depicts a close-up on the locking mechanism which creates the locked flat collar and leash. There are two loops used in this embodiment. The loop (B) is formed by sliding loop (A) through loop (D) and loop (E). The loop (B) is then placed around the animal's neck and fit for comfort. Loop (A) is placed over loop (E) and threaded through loop (D) with the entire length of the lead pulled through loop (D) to form a tight unit. Loop (A) is the hand hold position, which is not shown in close-up.

What is claimed is:

1. A combination collar and animal leash training device comprised of a single piece of flexible material ending in a dual sliding and lock device, that allows full adjustability to fit any size animal, and serves as a leash, as well as a halter collar, choker collar, or flat collar, whereby, providing positive or corrective feedback to the animal resulting in a successful transition from the training halter position to a traditional collar and leash combination.

2. A combination collar and animal leash training device in claim 1 wherein said flexible material may be comprised of, but not limited to, the following materials: flat nylon webbing, cotton webbing, braided rope, or leather.

3. A combination collar and animal leash training device in claim 1 wherein said flexible material may be comprised of, but not limited to, the following lengths: 7 ft, 8 ft, 10 ft.

4. A combination collar and animal leash training device comprised of a single piece of flexible material in claim 1 wherein said dual sliding and lock mechanism may be comprised of, but not limited to, the following materials: metal D or O rings, flat nylon webbing, cotton webbing, braided rope, or leather, or plastic D or O rings.
